(19) United States
(12) Patent Application Publication
(10) Pub. No.: US 2012/0287281 A1
(43) Pub. Date: Nov. 15, 2012

(54) PERSONALIZED AND DYNAMIC RESTAURANT INTERFACES AND SYSTEMS

(75) Inventors: Kimberly D. Williams, Oak Brook, IL (US); Richard A. Pollock, Oak Brook, IL (US)

(73) Assignee: Restaurant Application Development International LLC, Oak Brook, IL (US)

(21) Appl. No.: 13/551,465

(22) Filed: Jul. 17, 2012

Related U.S. Application Data
(63) Continuation of application No. 13/053,838, filed on Mar. 22, 2011.

(51) Int. Cl. H04N 7/18; G06Q 50/12

(52) U.S. Cl. 348/148; 348/E07.085

(57) ABSTRACT

A consumer profile can store consumer presence data and restaurant transaction data, as well as financial data and other secondary data. The consumer presence data can used to detect a consumer presence at a restaurant. A corresponding transaction between the restaurant and the consumer can be automatically initiated at the restaurant in response to the detected consumer presence at the restaurant and without requiring the consumer to explicitly request the transaction be initiated. A consumer can also be presented with a personalized interface for initiating a transaction at the restaurant in response to the consumer's presence being detected at the restaurant.

### CROSS-REFERENCE TO RELATED APPLICATIONS

This application is a continuation application and claims priority to U.S. patent Ser. No. 10/053,838, filed Mar. 22, 2011, entitled “PERSONALIZED AND DYNAMIC RESTAURANT INTERFACES AND SYSTEMS”, and is incorporated herein by reference in its entirety.

### BACKGROUND OF THE INVENTION

1. The Field of the Invention

The present invention is generally directed to consumer interfaces and transaction systems and, even more particularly, to customizable and dynamic restaurant interface systems.

2. The Relevant Technology

Restaurants, which represent one of the most visible public service industries, serve a broad range of consumer expectations. These expectations include different food preferences as well as increasing demand for more amenities and conveniences.

The restaurant industry is continuously developing new and interesting ways to satisfy consumer demands. For example, quick-service and drive-thru restaurants successfully target many consumers that place a premium on time and convenience. While most restaurants have particular specializations, it is common for restaurants to offer a variety of products and services. Most restaurants, for example, offer many different food items for purchase, and allow consumers to customize a chosen menu item by selecting different food preparation styles, selecting different ingredients for inclusion or exclusion, selecting different beverage and side combinations, selecting different portion sizes, selecting different packaging, and so forth.

Some restaurants even provide different products for the different times of the day or for different seasons of the year. Local restaurants may even provide unique products and services to accommodate local cultural needs and preferences.

Some restaurants also provide different menu boards for the different meals of the day or different food types to simplify the ordering process.

Despite the foregoing, there is an ongoing need for new products and services directed at improving convenience and accommodating different consumer appetites and demands within the restaurant industry.

### BRIEF SUMMARY OF THE INVENTION

The present invention extends to methods, systems, and computer program products for creating and utilizing consumer interfaces and for initiating and completing consumer transactions. While the embodiments of the invention are particularly suited for the restaurant industry, the scope of the invention extends beyond the restaurant industry to other industries that can also benefit from aspects of the claimed invention.

Embodiments of the invention include personalized and dynamic interfaces that facilitate the creation, modification and use of consumer profiles. Embodiments of the invention also include using the consumer profiles and corresponding personalized interfaces to initiate or otherwise facilitate consumer transactions.

Consumer profiles include both individual consumer profiles as well as group consumer profiles. The data contained in each consumer profile can be used to identify a corresponding consumer or group of consumers, as well as consumer devices and/or consumer preferences related to transactions between the consumer(s) and one or more service providers. For instance, a consumer profile can be accessed and utilized to facilitate automatic recognition of a consumer or consumer device when the consumer's presence is detected at a restaurant location. The consumer's preferences for certain transactions between the consumer and the restaurant can also be determined from the consumer profile data.

In one embodiment, a transaction performed by the restaurant or between the consumer and restaurant is automatically initiated upon detecting the consumer's presence at the restaurant, such as by scanning the license plate of the consumer's car at the restaurant, and without requiring the consumer to explicitly identify themselves and/or to explicitly identify the transaction. Instead, interface hardware is used to automatically identify the presence of the consumer at the restaurant. The consumer's profile is accessed and used to identify preferences for the transaction and to responsively trigger the automatic selection and initiation of the transaction and/or the presentation of a personalized interface related to the transaction.

Consumer data that can be used to identify the consumer includes descriptions of products associated with the consumer (e.g., vehicle descriptions, license plate data, etc.), loyalty cards, consumer gift cards, combined loyalty/gift cards, Radio Frequency Identification (RFID) data, mobile device identification data, physical descriptions of the consumer (e.g., facial recognition/image data, biometric data, voice pattern recognition, and the like), as well as any other data that can be used to uniquely identify the consumer.

The detected presence of a consumer or consumer device within a specified proximity to a location can also initiate a mapping of consumer profile data with third party and secondary data to further facilitate the automatic selection and initiation of the transaction or the presentation of a corresponding personalized interface. For instance, a restaurant can selectively provide different services and/or products to a detected consumer according to different predetermined criteria (e.g., locations, times, environmental conditions, and so forth) that are defined by the secondary data. This secondary data can be used in combination with the consumer profile data to facilitate automatic selection and initiation of a transaction and/or the presentation of a corresponding personalized interface related to the transaction.

In some embodiments, automatic payment for the transaction is also initiated and completed without the consumer having to provide payment information at the physical location where the transaction occurs. Instead, payment information linked to the consumer's profile is used to automatically initiate and/or complete payment for the transaction with the third party (e.g., bank, credit agency, and so forth) by using the third party financial data linked to the consumer profile.

In some instances, the restaurant has interface hardware (e.g., cameras, RFID and other wireless device sensors, biometric scanners, microphones, card readers, barcode scanners, and so forth) that can be used to identify the consumer or consumer device(s) and other secondary data. In other embodiments, third parties perform the actual identification of the consumer or consumer devices, as well as the secondary data (e.g., weather conditions, time or other predetermined criteria, for example) using interface hardware that is physically located at the restaurant or that is remotely located from the restaurant location (e.g., satellites, cell towers, and so forth).

The personalized interfaces that are presented to the consumer can be presented on interface hardware located at the restaurant, such as mechanical menu boards, electronic menu boards, Kiosk display screens, speakers, recording/playback devices, and so forth. The personalized interfaces can also be presented on consumer devices, such as, but not limited to phones, laptops, tablets or other smart devices. In regard to the foregoing, it will be appreciated that the personalized interfaces can include any combination of visual, tactile and/or aural interface presentation data.

The personalized interfaces and profile information can be used, in some instances, by the restaurant or other point of service entity to improve order accuracy and reduce the time required to complete a transaction, thereby improving the quality and convenience of the services and products provided to the consumer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of a computing environment that can be utilized to practice certain aspects of the invention;

FIG. 2A illustrates a flow diagram of acts, related to methods of the invention, which can be performed by consumer, server system and point of service entities;

FIG. 2B illustrates a flow diagram of acts, related to methods of the invention, which can be performed by consumer, server system and point of service entities;

FIG. 3A illustrates one embodiment of a personalized interface that can be presented to a consumer according to certain aspects of the invention;

FIG. 3B illustrates one embodiment of a personalized interface that can be presented to a consumer according to certain aspects of the invention; and

FIG. 3C illustrates one embodiment of a personalized interface that can be presented to a consumer according to certain aspects of the invention.

### DETAILED DESCRIPTION OF THE PREFERRED EMBODIMENTS

The present invention extends to methods, systems, and computer program products for creating and utilizing consumer interfaces and for initiating and completing consumer transactions.

Some embodiments of the invention include automatically identifying the presence of a consumer at a particular restaurant location and, in response, automatically selecting and initiating of at least part of a transaction between the consumer and the restaurant. In other embodiments, the identified consumer is presented a personalized interface related to the transaction.

While embodiments of the invention are particularly suited for the restaurant industry, it will be appreciated that the scope of the invention extends beyond the restaurant industry to other industries, including the educational, recreational, fitness, and business industries, or any other industry, which can benefit from automatically identifying the presence of a consumer or a consumer device at a particular establishment and responsively selecting and initiating of at least part of a transaction between the consumer and the particular establishment, or that can benefit from the presentation of personalized interfaces to patrons of the relevant establishments.

It will also be appreciated that many embodiments of the invention include or utilize combinations of special purpose and general-purpose computers having one or more processors and system memory. Embodiments within the scope of the present invention also include physical storage media and other computer-readable media for storing computer-executable instructions and/or data structures which are executed by one or more computing processor device(s). Such computer-readable media can be any available media that can be accessed by a general purpose or special purpose computer. Computer-readable media that store computer-executable instructions are physical computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Physical computer storage media (device(s)) includes RAM, ROM, EEPROM, CD-ROM, DVD, or other optical disk storage, magnetic disk storage or other magnetic storage devices, or any other medium which can be used to store desired program code means (software) in the form of computer-executable instructions or data structures and which can be accessed and executed by one or more processors of a general purpose or special purpose computer to implement aspects of the invention, such that they are not merely transitory carrier waves or propagating signals.

A “network”, as defined herein, includes one or more data links that enable the transport of electronic data between computers and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer RAM and/or to less volatile computer storage media (devices) at a computer. Thus, it should be understood that computer storage media (devices) can be included in computer components that also (or even primarily) utilize transmission media.

Computer-executable instructions comprise, for example, instructions and data which, when executed at one or more processors, cause a general purpose computer, special purpose computer, or special purpose processing device to perform a certain function or group of functions, including the functions described herein, as aspects of the invention. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer configurations, including, personal computers, desktop computers, laptop computers, tablet computers (e.g., iPads, Andorid tablets), message processors, hand-held devices (e.g., wireless phones, IPods, and so forth), multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computers, which are linked (either by hardwired data links, wireless data links, or by a combination of hardwired and wireless data links) through a network, both perform tasks. In a distributed system environment, program modules may be located in both local and remote memory storage devices.

The term “transaction”, as used herein, refers to an exchange of a good or service, often in exchange for currency or other goods or services. The term “transaction” can also refer to any act or combination of acts or functions related to the preparation or delivery of a good or service, or the notification of such, as well as any act or combination of acts associated with authorizing or providing an exchange of currency for the goods or services. At times, the term “transaction” is used interchangeably with the terms “consumer transaction” or “restaurant transaction”. For instance, in many embodiments, the term “transaction” specifically refers to a restaurant transaction that includes the preparation and/or delivery of a restaurant product or service, or the notification of such. The restaurant transaction can also include receipt of compensation from a consumer or third party. The consumer/restaurant transactions described in this paper can also include the generation of and/or delivery of information between the consumer and restaurant and/or a server system, through any suitable interface (e.g., speakers, display devices, human operator, computing networks, and so forth), including the presentation of the personalized interfaces described herein.

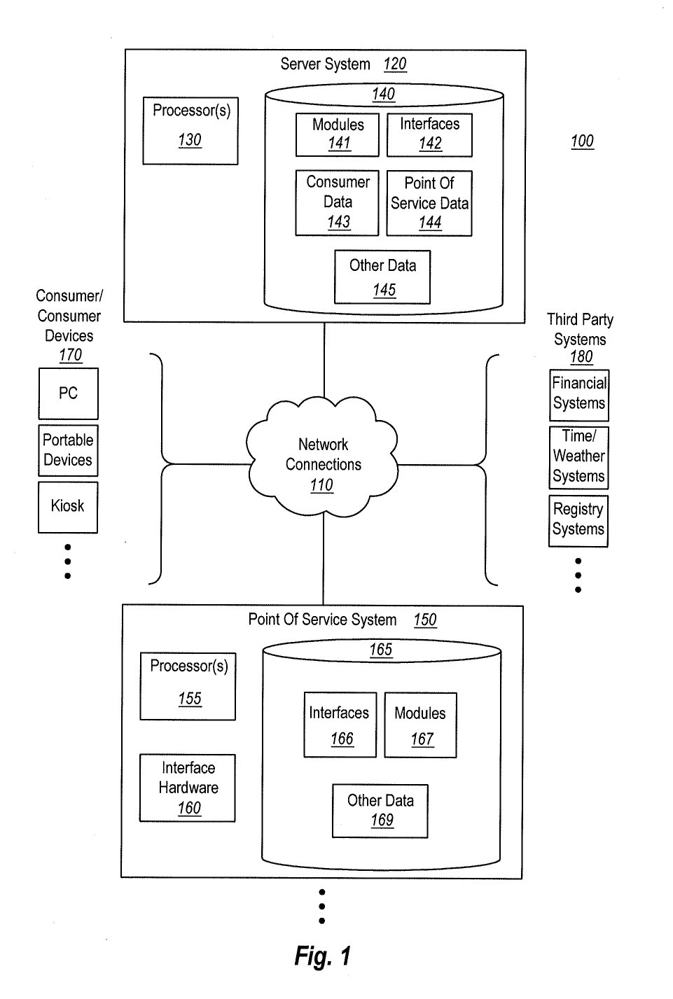

One embodiment of a suitable computing environment 100 that can be utilized for implementing the claimed invention is illustrated in FIG. 1. As shown, a network 110 interconnects a server system 120 with one or more point of service system(s) 150, consumer device(s) 170 and third party system(s) 180. The point of service system(s) 150 can comprise restaurants or other business entities.

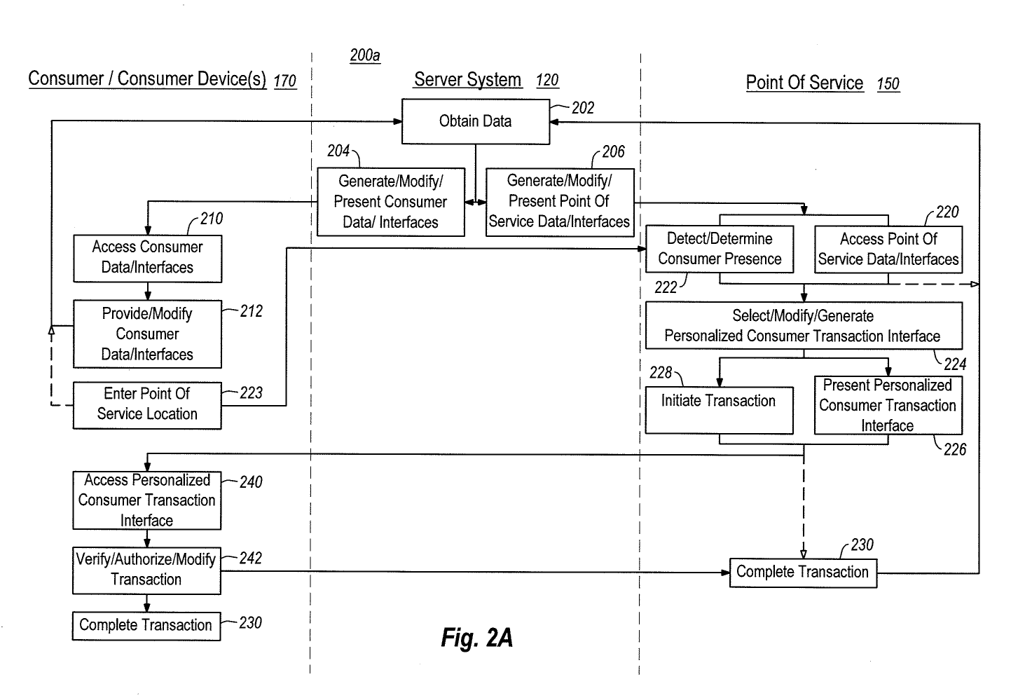

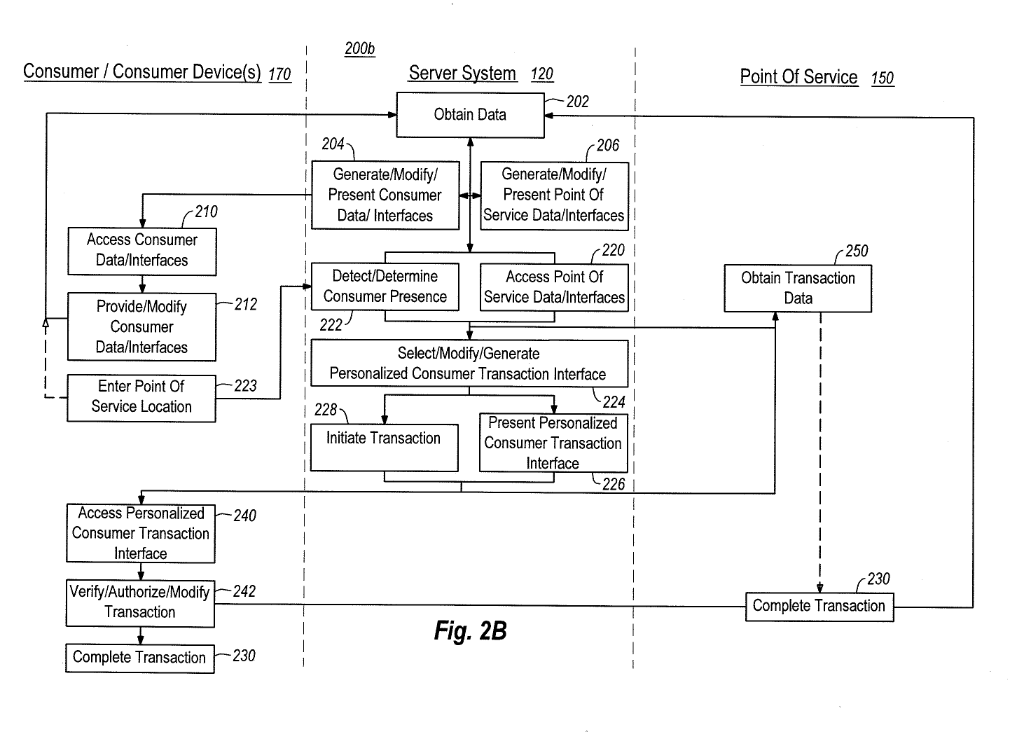

The server system 120 can be a stand-alone system or a distributed system that includes one or more processor(s) 130 (e.g., CPU device(s)) and storage media 140. The storage media 140 stores various computing modules 141, interfaces 142, consumer data 143, point of service data 144 and other data 145, which are collectively used by the server system 120 to perform various acts described throughout this paper, including acts that are performed by the server system 120 in reference to FIGS. 2A-2B.

The consumer data 143 includes consumer profile data that is sufficient to identify a consumer, one or more consumer devices (e.g., electronic devices or physical objects), consumer behaviors, consumer loyalty information, consumer purchase histories, and other consumer-related information. Each consumer can be associated with one or more corresponding consumer profiles that are based on any combination of consumer data as well as any secondary data. For instance, a first consumer can have a first profile associated with a first vehicle, such as a work vehicle, as well as a second profile associated with a second vehicle, such as a family vehicle. Similarly, a school can have a first profile associated with the school bus in combination with a particular coach's wireless device (e.g., phone, tablet, smart device, RFID tag, loyalty card, gift card, and so forth) and a second profile associated with the school bus in combination with a different coach's wireless device.

In view of the foregoing, it will be appreciated that a consumer can be restricted to consist of only an individual person or entity, alternatively, expanded to comprise a plurality of people or entities.

The consumer profile data can be provided to the server system 120 from the consumer, third parties and/or can be automatically generated in response to tracking consumer behaviors.

The consumer profile data can include consumer preferences, for example, that are automatically identified in response to tracked consumer behaviors. In some instances, for example, a consumer purchase history is used to identify a particular food item that is frequently purchased by a particular consumer. In such instances, a consumer profile can be developed for that consumer that associates the consumer with a preference for the particular food item.

Another example of using tracked consumer behavior to build profile data will now be given. In this example, a consumer driving a first vehicle (e.g., a work vehicle) frequently purchases a coffee at a first restaurant location in the morning hours, and frequently purchases certain meal combinations at one or more different restaurant locations in the afternoon hours. The purchased meal combinations include different beverages, depending on the local weather at the various purchase points. On Fridays, but not the other days of the week, the consumer also frequently purchases a breakfast sandwich. The same consumer also purchases a particular set of kid meals at various franchise locations on Saturdays, while driving a second vehicle (e.g., a family vehicle).

In the foregoing example, the consumer can be associated with several consumer profiles (e.g., a morning/work/weekday profile, a morning/weekend profile, a family weekend profile, an inclement weather profile, etc.), each of which can be based on different combinations of the foregoing consumer data, including vehicles driven, food preferences, time of day, day of the week, weather conditions, and so forth. The consumer profiles can also be associated with any combination of other consumer behaviors and consumer devices, including both electronic and physical objects. The consumer profiles can also be combined into a single composite consumer profile.

In some embodiments, a consumer is able to create and access account information and corresponding profile data through a consumer portal that is presented by one or more of the interfaces 142 of the server system 120 and that is displayed on one or more of the consumer devices 170 (e.g., desktop computer, portable computing devices, store kiosks, and so forth) or point of service systems 150. The consumer profiles can be modified in response to any data received by the server system 120 from the consumer devices 170, point of service systems 150, or third party systems 180.

The consumer data 143 can also include consumer loyalty information, and credit card and banking information that can be used to execute a financial transaction involving one or more third party systems 180 or point of service systems 150.

The point of service data 144 can include any data that is appropriate for the server system 120 to interface with the point of service systems 150, including locations, product and service menu options, store hours, special offers and so forth.

The other data 145 that can be utilized by the server system 120 includes advertising information received from the third party systems 180 or point of service systems 150, weather information, financial institution data, and so forth. This other data 145 can also include third party clearinghouse and registry information accessible to the server system 120, with or without the explicit permission of the consumer, such as DMV (department of motor vehicle) information, phone service data, and so forth.

The point of service system(s) 150 can be one or more stand-alone systems or distributed systems that include one or more processor(s) 155 (e.g., CPU device(s)) and storage media 165. The storage media 165 can store various interfaces 166, computing modules 167, and other data 169, which are collectively used by the point of service system(s) 150 to perform various acts described throughout this paper, including acts performed by the point of service system(s) 150 in FIGS. 2A-2B.

The other data 169 can include any combination of the consumer data 143, point of service data 144 and other data 145 described above, as well as other data specific to the point of service system(s) 150, such as employee information, inventory information, store procedure information, and so forth.

The interfaces described herein can include interfaces used to gather information and/or to present information, and include menu interfaces, internal restaurant interfaces, and the personalized consumer interfaces described herein.

Attention is now directed to FIG. 2A, which illustrates various acts in a flowchart 200a that can be performed by the consumer or consumer devices 170, the server system 120, and the point of service system(s) 150.

As shown, the server system 120 obtains data (act 202), including the data described above in reference to the server system 120. Thereafter, the server system 120 uses this data to generate, modify and/or present various consumer interface data (act 204), such as the consumer profile data and the interfaces that are used to gather the consumer profile data. The server system 120 also generates, modifies and/or presents point of service interface data (act 206) that can include, for example, the menu interfaces used by the point of service system(s) 150, as well as the personalized consumer interfaces, and other data, as described herein.

The consumer, on the other hand, utilizing one or more consumer devices 170, accesses the consumer data and interfaces provided by the server system 120 (act 210) and provides new consumer data (act 212). This consumer data includes any combination of financial data, purchase preference data, and consumer description data.

The financial data can include any account information sufficient to complete a financial transaction, such as credit card information, bank card information, loyalty card information, gift card information, combinations of the foregoing, and so forth.

The purchase preference data can include any information that is sufficient to describe preferences for food items or combinations of food items, based on a variety of purchase criteria, including store location, time of day, day of the week, weather conditions, vehicle driven, presence of consumer devices, and so forth.

The consumer description data can include any information that is sufficient to identify the consumer or consumer devices, including electronic devices and physical objects. In some instances, the consumer description data includes vehicle descriptions, license plate data, biometric data, RFID tag information, wireless device identifiers, traditional barcodes, QR matrix barcodes, and so forth.

In some instances, the data provided by the consumer (act 212) is obtained by the server system 120, as described above in reference to act 202. In other instances, the data is provided by one or more third party systems, as also described above in reference to FIG. 1.

The point of service system(s) 150 can also provide the relevant data to the server system 120, as well as access relevant point of service data and interfaces (act 220) that can be used by the point of service system(s) 150 to present interface menu options to the consumer, to verify consumer preferences and transactions, and to help detect and determine the presence of a consumer (act 222).

The point of service system(s) 150 can obtain profile data from the server system 120, which is used in conjunction with data obtained from interface hardware 160 (e.g., cameras, sensors, and other similar hardware/software devices that are capable of detecting a consumer's presence), to identify the consumer and consumer devices that are detected at the point of service systems(s) 150. Any combination of biometric sensors, RFID sensors, barcode scanners, QR code scanners, wireless device sensors, facial recognition camera systems, license plate recognition systems are utilized to detect and identify consumer presence, consumer identities, and consumer profiles. In some embodiments, the server system 120 can also access and use the foregoing information to identify a consumer and then notify the point of service system(s) 150 of the consumer's identity.

In other embodiments, the point of service system(s) 150 detects the consumer presence and identifies the consumer or consumer devices 170 in response to at least some of the data that is received from the server system 120 (act 220). For instance, the point of service system(s) 150 can obtain data (act 202) from the consumer or consumer devices 170 or other third party systems 180 (e.g., GPS tracking systems) that indicate that a consumer has entered a point of service location and can use this data with the profile data obtained from the server system 120 to identify the consumer or consumer devices 170.

The point of service system(s) 150 can also independently detect when the consumer has entered the point of service location (act 223) with interface hardware 160 (e.g., sensors, cameras, scanners) located at the point of service system(s) 150. The consumer enters the point of service location (act 223) by entering a brick and mortar building associated with the point of service 150, by crossing a predefined property line associated with the point of service system, or by approaching a predefined proximity to a point of service sensor.

Just like the server system 120 (act 206), the point of service system(s) 150 can also select, modify and/or generate the personalized consumer transaction interfaces (act 224) that are presented to the correspondingly appropriate consumers (act 226). In some instances, the point of service system(s) 150 will also automatically initiate a transaction (act 228) in response to the detected consumer presence. The transaction can then be executed to completion (act 230), even prior to receiving any explicit input from the consumer, by relying on information contained in the consumer's profile data. Completion of the transaction can include notifying the consumer that the requested goods or services are available or prepared. This notice can be provided on interface hardware 160 of the point of service system(s) 120, such as display screens, speakers, and so forth. Notice can also be provided by the point of service system(s) 150 using computing interfaces to send notice data to one or more of the consumer devices 170.

In other embodiments, the consumer is presented with the personalized transaction interface(s) (act 240) that are used to select, modify, verify and/or authorize a transaction (act 242) prior to the transaction being completed (act 230) so as to enable the preferred selection/modification/verification or authorization.

While flow diagram 200a spatially separates the various acts under the headings of the consumer/consumer devices 170, server system 120, and point of service 150, it will be appreciated that the scope of the invention also extends to embodiments in which the illustrated acts are performed by different entities than those that are suggested by the flow diagram 200a.

For instance, the server system 120 can obtain data (act 202) from third party entities, comprising any of the other data 145 described above. Similarly, it will be appreciated that many of the acts shown as being performed by the point of service system(s) 150 can also be performed, instead, by the server systems(s) 120. This is shown in FIG. 2B.

As shown in FIG. 2B, flow diagram 200b illustrates that the acts of detecting a consumer presence (act 222), selecting, modifying and/or generating the personalized consumer transaction interface (act 224), presenting the personalized interface (act 226), and initiating the transaction (act 228) are performed by the server system 120, instead of the point of service system(s) 150.

FIG. 2B further illustrates that additional acts can be performed, beyond those that are explicitly recited in the flow diagram 200a. In particular, flow diagram 200b further includes the act of obtaining transaction data (act 250), which can occur when the server system 120 previously authorizes a transaction directly with the consumer, by presenting the personalized interface (act 226) on a consumer device, contemporary with the time of the transaction, or at a previous time, such as a pre-purchased transaction that was previously authorized by a consumer.

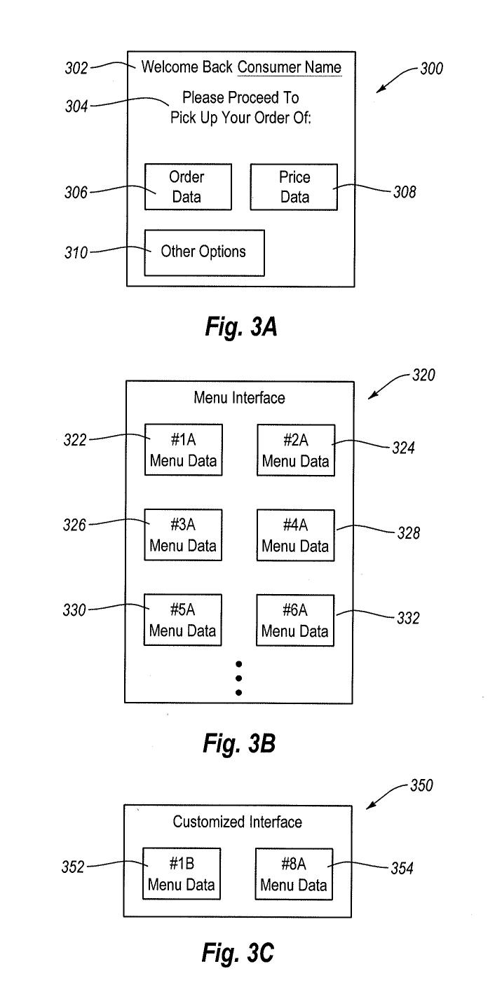

FIGS. 3A, 3B and 3C will now be used in reference to various examples of implementing certain aspects of the claimed invention.

### Example #1

In a first example, an individual consumer drives up to a restaurant and the consumer presence is detected at the restaurant with cameras located at the restaurant which scan the license plate of the vehicle driven by the consumer. Then, the restaurant provides the captured license plate information (or other device information) for identification of the consumer and a preferred transaction, based on the stored consumer profile. Alternatively, the restaurant accesses the consumer profile from its own database, to identify the consumer and a preferred transaction.

In other embodiments, an RFID tag on a consumer device or a signal from a consumer device (e.g., phone, tablet, or other device) is detected at the restaurant with one or more scanners, transceivers or other interface hardware, and the RFID tag or signal is used to identify the consumer. The traditional barcode or a QR code associated with a loyalty card or gift card can also be scanned to detect and identify the consumer. Biometric data associated with a fingerprint or facial feature can also be scanned to detect a consumer. Irrespective of how the consumer is detected/identified, a corresponding consumer profile is also accessed to further identify one or more preferred transactions for the identified consumer. This process can also include accessing and identifying relevant secondary data (e.g., time, day, location, weather, etc.).

In some instances, the one or more preferred transactions for the consumer are automatically initiated in response to detecting the presence of the consumer and accessing any relevant secondary data identified by the business, server, or one or more third parties. Notably, the preferred transaction(s) can be based on any combination of consumer profile data and secondary data.

By initiating the transaction in response to detecting the consumer, rather than waiting for the consumer to explicitly identify and request the transaction from a listing of transaction options, it is possible to significantly increase the speed of completing the transaction, to decrease the waiting time required for the consumer to receive their preferred good or service, and to ensure that the transaction accurately meets requested preferences.

In fact, according to some embodiments, the consumer can simply approach the pick-up window or pick-up counter of a restaurant without explicitly placing an order at or with the restaurant. Instead, the order is placed automatically in response to detecting the presence of the consumer at the restaurant.

In some instances, the financial payment for the transaction is also automatically initiated and/or completed as part of the transaction process. This can further increase the convenience for the consumer, and retailer, because the consumer does not have to pull out cash or other payment devices and the retailer does not have to manually process payment using the consumer's cash or other payment device. In such instances, the consumer may be required, or may not be required, to provide additional identification information (e.g., driver license, biometric scan, signature, and/or any other information) to further verify the consumer's identity and to help prevent fraudulent/unauthorized transactions prior to completing the transaction.

In other embodiments, the transaction is verified prior to completion through the use of a personalized transaction interface, such as personalized interface 300, which is presented to the consumer in response to the consumer's presence being detected at the restaurant or other business premises.

The personalized interface 300, which is presented to the consumer on a restaurant display and/or on the consumer's own personal devices (e.g., phone, tablet, etc.), for example, can include welcome information (302) that enables the consumer to verify that the consumer has been properly identified. Instruction information (304) can also be provided to enable the consumer to know what needs to be done to complete the transaction or to further initiate the transaction. Transaction order information, such as product or service descriptions (306), can also be provided, along with transaction cost information (308), to further enable the consumer to verify that the transaction that is being initiated, or that has already been initiated, is correct.

If the consumer wants to modify or cancel the transaction, in any way, the consumer can also be presented with additional options (310) that facilitate such actions.

In some embodiments, the additional options (310) can also include advertising information that is specifically targeted to the consumer, based on the consumer profile. The targeted advertising can include descriptions for other products and services offered by the restaurant or any other entity which would be determined to be of particular interest or relevance to the consumer.

### Example #2

In another example, a bus that is carrying a coach and a school football team drives up to a restaurant. The license plate of the bus is scanned and is used to identify a plurality of profiles associated with the corresponding school, including profiles of other school teams and organizations. The specific profile associated with the football team is further selected from the plurality of school profiles in response to receiving or detecting additional identification information associated with the school football team, such as detecting a wireless device associated with the coach, or in some other manner. Thereafter, the restaurant menu board, which is displayed on an electronic display screen or other interface hardware (160), is changed from a first state (having a first set of menu items) to a second state to reflect a personalized menu interface, such as menu interface 320 of FIG. 3B, which displays a second set of one or more menu items, such as items 322, 324, 326, 328, 330, and 332, which are associated with preferred menu choices of the players and coach of the school football team. The coach is then able to quickly identify the menu items to be purchased at the counter or at the drive-thru, significantly improving the convenience of ordering the menu items.

The present invention is also particularly suited for Just-In-Time (JIT) consumer transactions. For instance, it is possible for the preparation of the preferred menu items to immediately begin in response to detecting the presence of the football team, based on the profile settings and/or pre-purchase information that were previously submitted by the consumer. The restaurant, for example, can generate or receive the instructions to begin the preparation of the food items on internal interface hardware 160 (e.g., monitors and display screens) as soon as the relevant consumer (e.g., the football team) is detected and identified, and even prior to receiving verbal instructions from the consumer. This embodiment is particularly useful for improving the speed of completing the transaction, reducing consumer wait times, and improving the accuracy of the consumer's order.

### Example #3

The personalized interface 350, shown in FIG. 3C, illustrates how the selections of menu items provided to the consumer can be narrowed down to display only a very few menu items and, in some instances, to only a single ordering option. This can be particularly useful to simplify the ordering processes. In the specific example shown, for example, the customized menu interface 350 is presented to the corresponding consumer with only two ordering options (352 and 354). These options are identified from the consumer profile and/or secondary data in response to detecting and identifying the consumer.

In the present example, at least one of the two options (352 and 354) was not previously displayed on the restaurant menu board at a time just prior to the consumer entering the restaurant location. Instead, a standard menu interface or a personalized menu interface for another consumer was being displayed. By way of example, it is assumed that menu interface 320, which could be either a standardized menu interface or a personalized interface for another consumer, is displayed immediately prior to the new consumer being detected and identified. Subsequent to the consumer being identified and the consumer's profile being analyzed, with or without other secondary information, the new customized interface 350 is displayed, thereby replacing the previous interface 320.

Notably, customized interface 350 includes menu data item #1B (352) and menu data item #8A (354), at least one of which was omitted from the previous interface 320. Assuming menu item #1B (352) was not included in the previous interface, it is noted that menu item #1B (352) could still comprise a similar derivative or variant of a listing on the previous interface, such as menu item #1A (322). For instance, menu data items #1A (322) and #1B (352) could comprise similar menu combinations (e.g., sandwich, drink, and side) with minor differences and customizations. For instance, the different customizations could include a different size of one or more of the food items (e.g., small, medium, large, or supersize), a different set of ingredients to use on one or more of the food items (e.g., sauce, cheese, vegetable, etc.), a different food type for one of the food items (e.g., drink type, side, etc.), or any other difference.

The aforementioned example is particularly relevant for situations in which a consumer has particular dietary restrictions (e.g., gluten intolerance, diabetes, etc.) or has specific preferences that could be mistaken or misinterpreted during a conventional ordering process, such as drive-thru speaker systems that experience significant noise and interference. In particular, by referencing the consumer profile in response to detecting and identifying the consumer, it is possible to verify the consumer's preferences for the order and to ensure the accuracy of the order.

In some instances, the restaurant operator can still take an order placed by a consumer from a standardized restaurant menu board and over a conventional drive-thru speaker system, but can further verify the order with the consumer's preferences as defined by profile information presented to the operator on an internal restaurant interface. For instance, when the consumer orders item #1A (322) from a standardized menu interface (320), and identifies customizations to make to the order, the operator will already see the preferred order options associated with menu data item #1B (352) from the consumer profile and can verify the changes.

Alternatively, both the operator and consumer can be presented with the personalized interface 350 having menu option #1B (352) at the time of the order, after detecting and identifying the consumer. Then, when the consumer makes a selection from the customized interface 350, both the operator and consumer will be able to reference the same selected menu item (352).

In the foregoing example, the other menu option #8A (354) can be a predefined menu option that was explicitly identified by the consumer through a consumer portal with the server system 120. Alternatively, the menu option #8A (354) can be a menu option that was not selected by the consumer, but which is being presented to the consumer as an alternative choice based on perceived interests from other explicit selections from the consumer that were previously identified in consumer's profile. In yet another embodiment, the menu option #8A includes a preferred menu item associated with a second profile of the consumer, and menu option #1B (352) is a preferred menu item associated with a first profile of the consumer that is different from the second profile. For instance, the consumer may have different profiles associated with different menu preferences including, but not limited to, a traveling profile, a family profile, a business profile, a weekend profile, a team profile, an organization profile, an inclement weather profile, a good weather profile, etc.

### Example #4

In some embodiments of the invention, the point of service systems also include mechanisms for associating a consumer profile with particular menu preferences in real-time. For instance, an employee carrying a hand-held computing device, perhaps standing along the drive-thru lane beyond the menu board, can receive a verbal indication of a menu selection from a consumer. The hand-held computing device can include any combination of the interfaces described herein, including the menu interfaces that can be shown to the consumer.

The employee can also use the hand-held computing device to identify a consumer profile to help in the order taking and to access the personalized consumer interfaces.

In some instances, the employee uses the computing device to take a picture of the vehicle, scan consumer identification information, or enter consumer identification information into the system that will associate a particular order with the consumer or consumer device that is being scanned/entered. The consumer can then precede to pick-up the order which was prepared in response to the order being taken. When the consumer arrives at the pick-up window, the order will be delivered to the appropriate consumer in response to detecting the corresponding consumer or consumer device is approaching the pick-up window. Notably, the same or different information can be used to identify the consumer or consumer device at the pick-up window than was identified and associated with the order when the order was placed.

In one specific example, a consumer's vehicle is photographed by the portable computing device or another camera at the same time or around the same time the consumer places an order. Notably, the order can be taken with or without payment being made. The image of the vehicle is then linked to the particular order, by either the point of service or server systems. When the vehicle approaches the pick-up window, another image of the vehicle is captured (with the same or different device) and is used to identify the particular order that is associated with the photographed vehicle so that it can be delivered in a timely manner to the consumer. Preferably, preparation of the order is initiated when the order is taken.

When payment is not made at the time the order is placed, but is, instead, made at a later time, payment screens can also be prepared and displayed in response to the vehicle approaching the payment window and in response to detecting the particular order associated with the vehicle image data.

Other related embodiments are also facilitated. For instance, payment can also be made automatically, in some instances, by accessing financial data associated with a consumer's profile, as described above.

The foregoing embodiments can be particularly beneficial for locations that utilize a plurality of ordering drive-thru lanes that merge together into a single pick-up lane. In these situations, the sequences in which the orders are taken do not necessarily align with the sequences in which the vehicles approach the pick-up windows. In such situations, the systems of the invention can be utilized to provide desired synchronization.

### Example #5

As previously noted, the present invention extends to uses outside of the restaurant service industry. For instance, a consumer can benefit from the present invention as applied to the transportation industry. By way of example, a consumer can pull up to a gas pump at a gas station and can immediately begin pumping a preferred type of fuel for a particular vehicle in response to the consumer being detected and identified at the gas station. The consumer's identification and selection of a corresponding profile can be based on the captured image of the license plate on the consumer's vehicle. The consumer's profile preferences can also specify a type of preferred fuel (e.g., octane level, gasoline, diesel, natural gas, etc.) for that particular vehicle.

The gas pump can automatically initiate the transaction with the correct fuel selection based on the profile data without requiring the consumer to explicitly identify the type of fuel or provide payment at the gas pump. Financial payment can be made automatically, for example, with financial data included in the consumer's profile, without requiring the consumer to verify identity, since it is unlikely that the transaction would be fraudulent, having verified the identity of the consumer through the detected presence of the consumer's vehicle. Alternatively, additional verification can be provided. In either event, it will be appreciated that the convenience of the transaction will be greatly enhanced.

Similar embodiments include the automatic selection and/or payment of a preferred car wash, at a drive-thru car wash in response to reading the license plate of the vehicle being driven and without requiring the consumer to explicitly identify the type of wash or provide payment at the car wash location.

Other examples can also be envisioned within the scope of the invention for any of the aforementioned industries as well as other industries. Accordingly, it will be appreciated that the invention also includes any combination of the aforementioned examples as well as any of the aforementioned acts referenced herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automating processes during a transaction between a restaurant and a consumer, the consumer being associated with a consumer vehicle and the restaurant having at least two drive-through lanes and at least one pick-up lane, the method comprising:
obtaining, using an image-capturing device, a first set of license plate information from the consumer vehicle when the consumer vehicle is located within a predefined proximity of a drive-through lane at the restaurant;
receiving consumer transaction information from an interface device associated with the drive-through lane;
associating within a restaurant computer system the received consumer transaction information with the first set of license plate information;
obtaining, using an image-capturing device, a second set of license plate information when the consumer vehicle is located within a predefined proximity of a pick-up lane at the restaurant; and
identifying the consumer transaction information that is associated with the consumer vehicle at the pick-up lane by comparing within the restaurant computer system the second set of license plate information with the first set of license plate information.

2. The method of claim 1, wherein the first set of license plate information and the second set of license plate information are obtained from the same image-capturing device.

3. The method of claim 1, wherein the first set of license plate information is obtained from a first image-capturing device and the second set of license plate information is obtained from a second image-capturing device.

4. The method of claim 1, wherein the step of obtaining the first set of license plate information includes capturing a first image of a license plate of the consumer vehicle with the image-capturing device.

5. The method of claim 1, wherein the step of obtaining the second set of license plate information includes capturing a second image of a license plate of the consumer vehicle with the image-capturing device.

6. A system for automating processes during a transaction between a restaurant and a consumer, the consumer being associated with a consumer vehicle and the restaurant having at least two drive-through lanes and at least one pick-up lane, the system comprising:
one or more image-capturing devices configured to obtain (a) a first set of license plate information from the consumer vehicle when the consumer vehicle is located within a predefined proximity of a drive-through lane of the restaurant and (b) a second set of license plate information from the consumer vehicle when the consumer vehicle is located within a predefined proximity of a pick-up lane of the restaurant;
an interface device associated with the drive-through lane and configured to receive consumer transaction information from the consumer; and
a processor in electronic communication with the one or more image-capturing devices and the interface device, the processor being configured to:
obtain the first set of license plate information from the one or more image-capturing devices,
receive the consumer transaction information from the interface device,
associate the consumer transaction information with the first set of license plate information,
obtain the second set of license information from the one or more image-capturing devices, and
identify the consumer transaction information that is associated with the consumer vehicle in the pick-up lane by comparing the second set of license plate information with the first set of license plate information.

7. The system of claim 6, wherein the system includes one image-capturing device for obtaining both the first set of license plate information and the second set of license plate information.

8. The system of claim 6, wherein the system includes a first image-capturing device for obtaining the first set of license plate information and a second image-capturing device for obtaining the second set of license plate information.

9. The system of claim 34, wherein the one or more image-capturing devices capture a first image of a license plate of the consumer vehicle to obtain the first set of license plate information.

10. The system of claim 6, wherein the one or more image-capturing devices capture a second image of a license plate of the consumer vehicle to obtain the second set of license plate information.
